(19) United States
(12) Patent Application Publication
(10) Pub. No.: US 2004/0074850 A1
(43) Pub. Date: Apr. 22, 2004

(54) Integrated energy recovery system

(75) Inventor: Richard Martin Kelly, Buffalo, NY (US)

Correspondence Address: Praxair Technology, Inc., Law Department, M1-557, 39 Old Ridgebury Road, Danbury, CT, 06810-5113, US

(73) Assignee: Praxair Technology, Inc., Danbury, CT

(21) Appl. No.: 10/422,074

(22) Filed: Apr. 23, 2003

Related U.S. Application Data
(60) Provisional application No. 60/375,254, filed on Apr. 24, 2002.

(51) Int. Cl. B01D 61/00

(52) U.S. Cl. 210/806; 210/652; 210/636; 210/175; 210/259; 210/321.6; 210/416.1

(57) ABSTRACT

The present invention relates to the recovery of heat energy, e.g., the heat of compression, from the production of pressurized gases, in particular nitrogen (N₂), but also other gases such as compressed dry air. This invention is directed to a system and method for increasing the efficiency in use of energy by recovering energy normally wasted in one device and using the energy in another device needing the energy. In particular, this invention is directed to recovering the heat of compression from a gas generation plant to warm cooling water that is also used as feed water to an ultra pure water generation plant.

RELATED APPLICATION

This application claims the benefit of U.S. Provisional Application No. 60/375,254, filed on Apr. 24, 2002, the entire contents of which are incorporated herein by reference.

### BACKGROUND OF THE INVENTION

The manufacture of semiconductor devices such as, for example, those produced on wafer substrates requires significant amounts of both materials and energy. In particular, semiconductor production requires the use of ultra pure water (UPW) and pressurized gases such as nitrogen and compressed dry air (CDA). In general, systems and equipment for generating pressurized gases and ultra pure water consume large quantities of energy.

For example, the gas generation equipment used to produce nitrogen and compressed dry air typically rejects heat of compression into the environment. There are several methods employed for rejecting this heat into the environment.

One method includes the use of a dedicated, recirculating cooling water system to remove the heat. Heat is transferred to cooling water and results in a rise in cooling water temperature. The heat is then removed from the cooling water by evaporation via a cooling tower. Contact with air in the cooling tower causes evaporation of a portion of the cooling water and results in a lowering of the water temperature. The remaining cooled water is then recirculated and combined with a make-up water stream for further heat transfer. The temperature of the cooling water is determined by atmospheric conditions and the efficiency of water/air contact in the cooling tower. This method is typically used to remove heat of compression, as well as other minor waste heat, from gas generation equipment such as nitrogen generation plants and CDA plants.

Heat generated by a gas production process can also be expelled into a stream of cooling water taken from a body of water such as an ocean, lake or river. Cooling water taken from the body of water removes heat from the gas generation equipment as previously described, and then the return cooling water is passed back in to the same body of water. In this case, the cooling water temperature is the temperature of the body of water.

Another method for removing heat from gas generation equipment employs air-cooled heat exchangers where heat is directly rejected to the atmosphere by the heating of atmospheric air. The prevailing dry bulb temperature determines the temperature of the air.

In a separate and distinct process, ultra pure water is produced from a feed water stream. In some processes, the feed water stream is heated prior to treatment in the UPW plant. Heat used to raise the temperature of the water feed stream is provided by an external heat source, for example, by a hot water boiler system. These methods of heating the feed water stream incur significant capital and operating costs.

The use of energy and materials in the production of ultra pure water and pressurized gases is generally poorly optimized. Utilities are used in excess with little or no process integration to lower consumption or re-use to recover value. Further, multiple utility systems are often installed and are on-line in order to provide a high level of supply reliability. In particular, heat of compression used in generating pressurized gas often is wasted, while fuel is used to generate energy to heat feed water to produce ultra pure water.

Therefore, there is a need for processes for the production of pressurized gases and ultra pure water that have reduced utility consumption over traditional non-integrated systems. There is also a need for processes that exhibit improved process reliability.

### SUMMARY OF THE INVENTION

The present invention relates to the recovery of heat energy, e.g., the heat of compression, from the production of pressurized gases, in particular nitrogen (N₂), but also other gases, such as compressed dry air. This invention is directed to systems and methods for increasing the efficiency in use of energy by recovering energy normally wasted in one device and using the energy in another device needing the energy. In particular, this invention is directed to recovering the heat of compression from a gas generation plant to warm cooling water that is also used as feed water to an ultra pure water generation plant. UPW generation plants often comprise at least one reverse osmosis purification unit. UPW feed-water is usually heated before being directed to the reverse osmosis purification unit in order to improve the permeation of water. Advantageously, the present invention reduces or eliminates the need to heat this water by expending additional energy, for example, by using steam or hot water generated by a facility's main boiler plant.

In one aspect, the present invention is directed to a system for producing compressed gas and purified water comprising: (a) means for compressing a gas, thereby forming a heat source; (b) means for transferring heat from the heat source to a water stream, thereby forming a heated water stream; and (c) means for purifying the heated water stream.

For example, one or more gas compressors each having one or more compression stages are used to compress a gas, e.g., atmospheric air. In a preferred embodiment, heat is transferred from the compressed gas heat source to a water stream using one or more heat exchange devices such as, e.g., indirect heat exchanger systems. In another preferred embodiment, the heated water stream is directed to a water purification apparatus such as a reverse osmosis unit to produce a stream of purified water. A water conduit is connected to the indirect heat exchanger and the water purification apparatus such that cooling water is provided to the heat exchanger and exiting heated cooling water is provided to the water purification apparatus.

Thus, in one embodiment, the present invention also includes a system for producing compressed gas and purified water comprising: (a) a gas compressor for producing a compressed gas stream; (b) at least one heat exchanger having a compressed gas inlet, a compressed gas outlet, a water inlet and a water outlet and wherein heat is transferred from the compressed gas stream to a water stream to produce a heated water stream; and (c) a water purification apparatus for purifying the heated water stream, the water purification apparatus being in fluid communication with the heat exchanger.

In addition, a method for producing compressed gas and purified water is provided. The method comprises (a) compressing a gas to produce a compressed gas stream; (b) directing the compressed gas stream through a heat exchanger wherein heat is transferred from the compressed gas to a water stream, thus producing a heated water stream; and (c) directing the heated water stream to a water purification apparatus wherein the heated water stream is at least partially purified to form a purified water stream.

The systems and methods of the present invention reduce a semiconductor facility's requirements for steam and/or hot water. The invention also significantly reduces or eliminates the need for a dedicated cooling water plant for the gas generation equipment, thereby reducing reliance on or eliminating a major piece of equipment and thereby improving process reliability. Other advantages of the invention include reduced energy consumption by the compressors during the summer months due to water supply temperatures that are lower than the prevailing wet bulb temperatures; reduced water consumption through the mitigated need to perform evaporative cooling, e.g., through cooling towers; and lower gas generation plant cost and footprint by eliminating the need for a dedicated cooling tower.

### BRIEF DESCRIPTION OF THE DRAWINGS

The FIGURE is a schematic diagram illustrating an embodiment of the invention in which heat recovered from a gas generation system (e.g., a nitrogen generation system) is supplied to an ultra pure water generation system.

### DETAILED DESCRIPTION OF THE PREFERRED EMBODIMENT

The foregoing and other objects, features and advantages of the invention will be apparent from the following more particular description of preferred embodiments of the invention, as illustrated in the accompanying drawing. The drawing is not necessarily to scale, emphasis instead being placed upon illustrating the principles of the invention.

The present invention is directed to systems and methods for recovering energy from a compressed gas. The invention is particularly useful for the production of nitrogen gas and ultra pure water used in the manufacture of semiconductor devices. The invention relates to the recovery of heat energy, for example, the heat of compression, from a compressed gas. In particular, the invention is directed to the recovery of the heat of compression generated in the production of pressurized gases such as, for example, nitrogen (N₂) or compressed dry air (CDA). Energy is recovered from the compressed gas by transfer to an appropriate heat exchange fluid such as, for example, water or chemically treated water that is subsequently directed to other process equipment and consumed in the production of a product stream. Preferably, the heat exchange fluid is water and the heated water is subsequently used in the production of a purified water product such as ultra pure water. In one aspect, a portion of the heated water is used as a make-up stream fed to other process equipment such as, for example, a boiler, cooling tower, or wet scrubber.

The FIGURE is a schematic diagram illustrating an embodiment of the invention in which heat recovered from a gas generation system is supplied to an ultra pure water generation system. In particular, the integrated system includes a nitrogen gas generation system and an ultra pure water generation system. Ultra pure water produced by practicing the present invention is suitable for use in the fabrication of microelectronics such as semiconductor devices, among other applications. For example, ultra pure water is generally considered, as described in International Technology Roadmap for Semiconductors (ITRS), 2001 edition, published by the Semiconductor Industry Association, as water with greater than 18.1 megaohm resistivity and containing less than 1 part per billion (ppb) ions (e.g., cations, anions, or metals), total organic carbon, silica (e.g., dissolved and colloidal), particles and bacteria. The following description of embodiments is made with respect to the FIGURE.

Referring to the FIGURE, feed gas stream 10 is fed to one or more compression stages. Suitable compression stages comprise, for example, reciprocating, axial, rotary, and centrifugal gas compressors. Feed gas stream 10 is any gas stream that contains a gas (e.g., nitrogen) for which compression is desired. In a preferred embodiment, feed gas stream 10 is air such as, for example, atmospheric air. Feed gas stream 10 can be supplied at any temperature or pressure, for example, at atmospheric temperature and pressure. Alternatively, the gas can be supplied at a temperature and/or pressure higher or lower than atmospheric conditions.

Feed gas stream 10 is compressed by first compressor stage 12 to form first stage product stream 14 that has a pressure and temperature elevated relative to feed gas stream 10. In a preferred embodiment, in order to reduce the energy required in subsequent compression stages, first stage product stream 14 is subsequently cooled by indirect heat exchange with cooling water stream 16 in first heat exchanger 18 thus forming cooled first stage product stream 20.

Cooled first stage product stream 20 is then compressed by second compressor stage 22 to form second stage product stream 24. Second stage product stream 24 emerges from second compressor stage 22 at an elevated temperature and pressure. Second stage product stream 24 is cooled by indirect heat exchange with cooling water stream 26 in second heat exchanger 28 to produce cooled second stage product stream 30. The cooled second stage product stream 30 is then compressed in final compressor stage 32 to form third stage product stream 34. Third stage product stream 34 emerges from final compressor stage 32 at elevated temperature and pressure and is cooled by indirect heat exchange with cooling water stream 36 in third heat exchanger 38 to produce cooled product stream 40. Alternatively, heat is transferred from product streams 20, 30, or 40 to a cooling water stream via an intermediate heat transfer medium, for example, via a circulating heat transfer fluid. This alternative method of heat transfer, though, requires additional process complexity.

While the above-described embodiment of the invention includes three compression stages, any number of compression stages may be employed to produce a gas stream of a desired pressure. One of ordinary skill in the art can determine the necessary number of compression stages to produce a gas of a desired pressure without undue experimentation.

Furthermore, while intercooling of the compression stages is illustrated in the instant embodiment, the invention includes the general, indirect recovery of heat from a compressed gas. As such, the present invention includes the recovery of heat from a gas stream following one or more compression stages. For example, heat is recovered from a gas stream after a single stage of gas compression. Alternatively, heat is recovered from a gas stream after at least two stages of gas compression. In addition, while cooling water streams 16, 26, and 36 are illustrated in the FIGURE as deriving from a common source (stream 62), in another embodiment, one or more of these streams is derived from a source independent of the other cooling water streams.

When the feed gas stream comprises atmospheric air, feed gas stream 10 typically contains moisture as well as other gaseous compounds commonly found in the atmosphere. As feed air stream 10 is compressed and cooled, the gas eventually reaches a saturation point and the moisture starts to condense. Preferably, condensate is removed from the process streams. For example, the first, second and/or third heat exchangers 18, 28 and 38 contain drain ports or are immediately followed by separation units to remove the condensate.

When the feed gas stream 10 contains adequately low moisture levels, the process produces cooled third stage product stream 40 substantially free of moisture. More commonly, when the feed gas stream 10 comprises atmospheric air, cooled third stage product stream 40 emerges from the third heat exchanger 38 saturated with moisture. Before entering cryogenic rectification process 56, moisture is substantially removed from cooled third stage product stream 40 to prevent freezing and blockage of the cryogenic equipment. In order to remove the remaining moisture, cooled third stage product stream 40 is further cooled by indirect heat exchange with chilled water in fourth heat exchanger 42 to a temperature typically between about 32° F. (0° C.) and about ambient temperature. Thus, moisture is condensed and removed in fourth heat exchanger 42 via drain ports or is removed immediately following the heat exchanger using a separation unit.

The cooling load associated with fourth heat exchanger 42 is provided by refrigerant stream 44 that takes heat from cooled third stage product stream 40 and transfers that heat by indirect heat transfer to cooling water stream 46 in fifth heat exchanger 48, thereby producing chilled gas stream 50. Refrigerant stream 44 comprises any suitable heat transfer fluid. Suitable heat transfer fluids are selected using techniques well known to those of ordinary skill in the art. While cooling water stream 46 is illustrated in the FIGURE as deriving from the same common source as cooling water streams 16, 26, and 36, in another embodiment, one or more of these streams is derived from a source independent of the other cooling water streams.

In some embodiments, cooled third stage product stream 40 or chilled gas stream 50 comprises one or more components subject to freezing under cryogenic conditions. For example, cooled third stage product stream 40 or chilled gas stream 50 contains moisture and/or carbon dioxide. In one embodiment, cooled third stage product stream 40 and/or chilled gas stream 50 are directed to a purification unit, for example, purification unit 52, where substantially all remaining moisture and/or substantially all carbon dioxide are removed.

In one embodiment, purification unit 52 comprises one or more absorption beds that adsorb moisture and/or carbon dioxide. For example, cooled third stage product stream 40 and/or chilled gas stream 50 are directed to a purification unit comprising an adsorption bed wherein the adsorption process is reversible. In one embodiment, when a first bed becomes loaded with adsorbents, the gas stream is directed to a second unloaded bed, and the first bed is regenerated to remove the adsorbents. Purified gas stream 54 emerges from the purification unit and is directed to cryogenic rectification process 56 for rectification into desired component stream 58 and waste stream 60. For example, purified gas stream 54, comprising compressed purified air, is directed to cryogenic rectification process 56 for rectification into desired component stream 58, comprising nitrogen gas, and waste stream 60.

In one embodiment, only moisture and carbon dioxide are removed from the purified gas stream 54 prior to cryogenic rectification. However, if a higher purity product is desired, a further purification step is used to remove or reduce the concentration of other compounds such as, for example, hydrogen and carbon monoxide.

In a nitrogen gas generation process, a catalytic oxidation unit is commonly situated between third heat exchanger 38 and fourth heat exchanger 42 or between fourth heat exchanger 42 and purification unit 52. This catalytic oxidation unit typically operates at elevated temperatures and oxidizes hydrogen to water and/or carbon monoxide to carbon dioxide. Moisture and/or carbon dioxide are then substantially removed in purification unit 52 as described above.

The present invention is also useful for generating compressed dry air (CDA). For example, CDA is co-generated from the nitrogen generation system by taking a side stream from purification unit 52. Taking a CDA side stream thus results in an increased cooling duty for the gas generation system.

Cooling water is supplied to heat exchangers 18, 28, 38 and 48. As described herein, the cooling water is treated or untreated water. For example, the cooling water supplied to the heat exchangers is chemically treated and/or filtered prior to being directed into heat exchangers 18, 28, 38 and 48.

The present invention includes directing cooling water supply stream 62 into heat exchangers 18, 28, 38 and 48. In a preferred embodiment illustrated in the FIGURE, cooling water supply stream 62 is directed to first, second, third and fifth heat exchangers 18, 28, 38 and 48 in parallel so that each heat exchanger receives cooling water at the lowest possible temperature. Cooling water streams 16, 26, 36 and 46 enter first, second, third and fifth heat exchangers 18, 28, 38 and 48, respectively; are heated; and exit as streams 64, 66, 68 and 70, respectively, at temperatures of, for example, about 50° F. (10° C.) to about 212° F. (100° C.); 55° F. (12.8° C.) to 150° F. (65.6° C.); 60° F. (15.6° C.) to 110° F.(43.3° C.); 65° F. (18.3° C.) to 95° F. (35° C.); 70° F. (21.1° C.) to 90° F. (32.2° C.); or about 75° F. (23.9° C.) to about 85° F. (29.4° C.), preferably about 80° F. (26.7° C.). In one embodiment, the volumetric flow rate of stream 62 is selected so that it exits the heat exchangers at a chosen temperature, for example, approximately 80° F. (26.7° C.), regardless of the initial temperature of stream 62. In one embodiment, two or more streams are combined to form a cooling water return stream. In the embodiment illustrated in the FIGURE, streams 64, 66, 68, and 70 are combined to form cooling water return stream 72. At least a portion of one of the heated cooling water streams, e.g., streams 64, 66, 68, and 70, is fed to the UPW generation system. In another form, only streams 64, 66, and 68 are combined to form cooling water return stream 72, while the heat recovered from heat exchangers 42 or 48 is otherwise disposed of.

If the volumetric flow rate of the cooling water return stream 72 is in excess of that required by the UPW system, excess stream 74 is diverted from cooling water return stream 72. Excess stream 74 is directed to other facility equipment, for example, as make-up water for cooling towers, boilers, or wet scrubbers, or is directed to a disposal facility. At least a portion of cooling water return stream 72 is directed to the UPW generation system as stream 76.

Now referring to the ultra pure water (UPW) generation system of the FIGURE, feed water stream 78 may be taken from the municipal water supply, or a source providing similar quality water, e.g., lake, pond, aquifer or process water, at a rate sufficient to generate the required rate of UPW product. Feed water stream 78 is passed into filter unit 80. Filter unit 80 preferably comprises multimedia filtration to remove coarse solids from the feed water. Filter unit 80 also includes finer filtration means such as cartridge filters, as necessary. In one embodiment, filtered stream 82 exits filter unit 80 and then is treated to remove potential scale-forming cations such as, e.g., magnesium and calcium. For example, the filtered stream is softened and/or various scale-inhibiting chemicals are added such as via chemical stream 84 to form treated feed water stream 86.

Alternatively, cooling water supply stream 62 is derived directly from a municipal water supply, make-up water supply, lake or aquifer and does not pass through filter unit 80 and/or have any chemicals added to it.

In one embodiment, at least a portion of the treated feed water stream is diverted as cooling water supply 62 and fed to the gas generation system. Any remaining portion of treated feed water stream 86 is combined with a UPW recycle stream, e.g., UPW recycle stream 124, and/or a heated water product stream directed from the gas generation system, e.g., stream 76. UPW recycle stream 124 is a relatively pure water stream with little or no particulate, chemical or biological contamination. It is recycled back into the process to reduce the overall feed water demand of the process. In one form, the UPW plant operates without any UPW recycle stream, and thus increases the required volumetric flow of feed water stream 78.

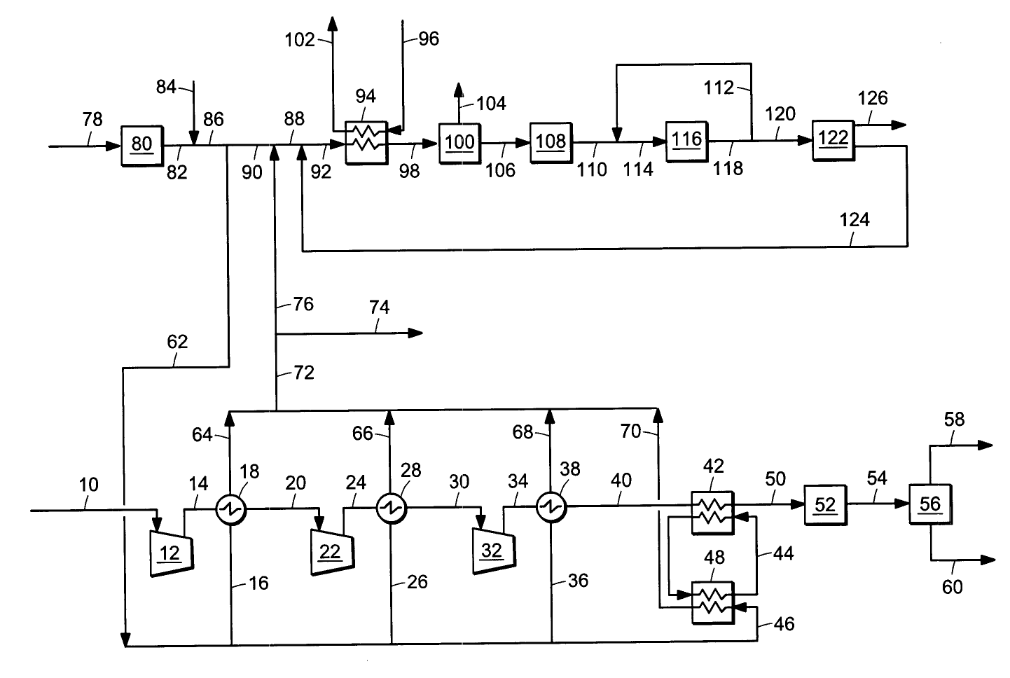

If the required volumetric flow rate of UPW feed water, e.g., stream 88, is in excess of the required volumetric flow rate of nitrogen plant cooling water supply, e.g., stream 62, additional UPW feed water is added to the UPW plant, e.g., via stream 90. As shown in the FIGURE, any remaining portion of treated feed water stream, e.g., stream 90, is combined with stream 76 from the gas generation system to form stream 88. Stream 88 is then combined with UPW recycle stream 124 to form mixed feed stream 92. In one embodiment (not shown in FIG. 1), at least a portion of UPW recycle stream 124 is combined with cooling water supply stream 62, a feed to the gas generation system.

A stream, e.g., stream 92, comprising at least a portion of heated water product stream directed from the gas generation system (e.g., stream 76) is heated as necessary for downstream processing. For example, mixed feed stream 92 is directed into heat exchanger 94 in indirect heat transfer relation to supply stream 96, for example, a heat transfer medium stream such as a steam or hot water supply stream. The mixed feed stream 92 is heated to about 60° F. (15.6° C.) to about 212° F. (100° C.), e.g., about 65° F. (18.3° C.) to about 150° F. (65.6° C.), more usually about 70° F. (21.1° C.) to about 90° F. (32.2° C.) and typically approximately 80° F. (26.7° C.) and exits heat exchanger 94 as heated feed water stream 98. Heating mixed feed stream 92 to about to about 70° F. (21.1° C.) to about 90° F. (32.2° C.), e.g., about 80° F. (26.7° C.), before entering reverse osmosis unit 100 lowers the viscosity of the water stream and aids separation in the reverse osmosis unit. Advantageously, practice of the present invention reduces the amount of energy that would otherwise be required to heat mixed feed stream 92 if that stream did not contain at least a portion of heated water product stream 76 directed from the gas generation system. Supply stream 96 is cooled and exits heat exchanger 94 as return stream 102, e.g., comprising condensate or hot water. In one embodiment, supply stream 96 is returned to a heat generation device, e.g., a boiler plant, for re-heating.

Alternatively, a feed water stream, e.g., stream 90 or stream 88, is heated to a higher temperature than desired for reverse osmosis unit 100, such that when a cooler UPW recycle stream, e.g., UPW recycle stream 124, is added, the temperature of the mixed stream is the desired operating temperature. This heating is accomplished using, for example, a indirect heat exchanger supplied with hot water or steam and alleviates the need for heat exchanger 94.

Heated feed water stream 98 is then pumped to high pressure and passes into reverse osmosis unit 100 where most of the Water is forced through a membrane to substantially remove dissolved ions as well as significant amounts of dissolved carbon and silicon compounds. These impurities are removed in waste stream 104, while permeate water stream 106 is directed to purification process 108.

Permeate water stream 106 is directed to purification process 108 wherein the permeate stream is further purified, as necessary, thereby forming purified water stream 110. Purification process 108 comprises one or more apparatus selected from the group consisting of: deionization units, to further remove dissolved ions; degasification units, to remove dissolved high volatility compounds; sterilization units, e.g., ultra-violet sterilization, to prevent bacterial growth; and filtration units. Purification process 108 is generally necessary to generate ultra pure water having desired impurity levels, for example, of less than about 1 part per billion (ppb) on a weight basis, however the exact technologies used depends on the starting quality of the feed water and the desired purity of the purified water product.

In one embodiment, purified water stream 110 exits the purification process 108 and is combined with UPW recirculation stream 112 to form stream 114. Stream 114 is then directed to final polishing process 116. The final polishing process includes, as necessary, one or more processes such as, for example, ion exchange, ultra-violet sterilization, and microfiltering. UPW product stream 118 emerges from polishing process 116.

UPW demand stream 120, a portion of the UPW product stream 118, is used by semiconductor manufacturing and other equipment 122. In one embodiment, the remainder of UPW product stream 118, consisting of UPW recirculation stream 112, is combined with purified water stream 110 and passes again through final polishing process 116. This constant recirculation helps to prevent any bacterial growth in stagnant lines and constantly removes any contaminants added to the UPW in the distribution system. Demand stream 120 is used by semiconductor manufacturing and other equipment 122 and, depending on the spent purity, is drained into UPW recycle stream 124 or wastewater stream 126.

In the embodiment illustrated in the FIGURE, only reverse osmosis unit 220 and cryogenic rectification process 56 are shown as producing waste streams, e.g., streams 104 and 60. However, any of the other unit operations such as, for example, filter unit 200, purification unit 52, purification process 108, and final polishing process 116 may also produce waste streams.

In other embodiments, the order of water purification unit operations such as, for example, filter unit 200, reverse osmosis unit 100, purification unit 52, purification process 108, and final polishing process 116 differs from the embodiment shown in the FIGURE. In addition, the present invention also encompasses processes having additional or different water purification unit operations from those described herein. Such additional or different water purification unit operations are well known to those of ordinary skill in the art. The present invention also encompasses UPW generation systems having various recycle streams, e.g., stream 124, or recirculation streams, e.g., stream 112. For example, at least a portion of UPW recycle stream 124 is combined with cooling water supply stream 62, a feed to the gas generation system or at least a portion of UPW recycle stream 124 is combined with stream 90 or heated feed water stream 98. Recycle streams and recirculation streams are selected using methods well known to those of ordinary skill in the art.

Although pumps or storage tanks are not indicated in the description of the embodiment shown in the FIGURE, they are present at various points throughout the system.

The invention is illustrated by the following examples, which are not intended to be limiting in any way.

### EXEMPLIFICATION

The heating and cooling duties of nonintegrated nitrogen gas and ultra pure water plants are calculated as a function of ambient conditions. Duties are then calculated for integrated plants wherein heat is recovered from the nitrogen gas generation and is used for the production of ultra pure water.

### Comparative Example

This comparative example describes computational models describing non-integrated nitrogen gas generation and ultra pure water production plants.

A typical semiconductor manufacturing facility processing 30,000 eight-inch (20.32 cm) wafers per month demands approximately 180,000 standard cubic feet per hour (scfh) (5097 standard m³/hour) of nitrogen and 520 gallons per minute (gpm) (1968 liters/minute (L/min)) of ultra pure water (UPW). The following design day conditions are assumed: 1% design day conditions of about 100° F. (37.8° C.), 37% relative humidity; average conditions of about 70° F. (21.1° C.), 57% relative humidity; and 99% design day conditions of about 24° F. (−4.4° C.), 80% relative humidity. The year around atmospheric pressure is assumed to be 14.7 pounds per square inch, absolute (psia) (1 atmosphere). The municipal feed water temperature is assumed to vary between 50° F. (10° C.) and 70° F. (21.1° C.) with an average of 60° F. (15.6° C.).

The first model describes a nitrogen gas generation plant, with a nitrogen recovery rate of 50%, comprising intercooled gas compression stages. An atmospheric air stream having a volumetric flow rate of 360,000 scfh (10194 standard m³/hour) is fed to a series of three gas compression units operating with compression ratios of 2.45 and adiabatic efficiencies of 73%. Following each compression stage, an indirect heat exchanger is employed to transfer heat energy from resulting compressed air streams to a cooling water subsystem. Each of the three heat exchangers has a cold-end approach temperature of 10° F. (−12.2° C.) and an airside pressure drop of 2 psi (13.8 kilopascals (kPa)). A fourth indirect heat exchanger further cools the product stream emerging from the above-described third indirect heat exchanger to produce a chilled air stream having a temperature of 45° F. (7.2° C.).

Cooling water is directed from a common source cooling water supply to each of the four indirect heat exchangers. Heated cooling water streams emerging from the heat exchangers are combined and fed to a cooling tower to produce the common source cooling water supply for the heat exchanger network described above. The temperature of the common source cooling water supply is determined using the projected atmospheric wet bulb temperature for each of the design days modeled. Under 99% design day conditions, however, where the wet bulb temperature is below freezing, the cooling water temperature is assumed at or above about 40° F. (4.4° C.).

The second model describes a UPW generation plant. The model includes the following characteristics. A feed water stream of city provided water having a flow rate of about 390 gpm (1476 L/min) is combined with a UPW recycle stream with a flow rate of about 260 gpm (984 L/min) and a temperature of 70° F. (21.1° C.) to produce a combined feed stream. The combined feed stream is heated in an indirect heat exchanger using a recirculating steam/hot water supply stream to produce a heated feed water stream at 80° F. (26.7° C.). The heated feed water stream is directed to a reverse osmosis water purification unit wherein 20% of the heated water feed volume, or about 130 gpm (492 L/min), is discarded as a waste stream and 80% product, or about 520 gpm (1968 L/min), is recovered and comprises an UPW demand stream. 50% of the volumetric flow of the UPW demand stream is recycled to combine with the feed water stream as the UPW recycle stream.

Table 1 shows cooling duties calculated using the nitrogen gas generation plant model and heating duties calculated using the UPW generation plant model. The amount of heat rejected by the nitrogen plant and the amount of heat required by the UPW plant is calculated for 1%, average, and 99% design days.

TABLE 1
Heating and cooling duties of non-integrated N₂ and UPW plants.

| | 1% | | 99% |
|---|---|---|---|
| | Design | | Design |
| Case: | Day | Average | Day |
| Base Data | | | |
| Ambient Temperature (° F.)/(° C.) | 100/37.8 | 70/21.1 | 24/−4.4 |
| Relative Humidity (%) | 37 | 57 | 80 |
| City Water Temp. (° F.)/(° C.) | 70/21.1 | 60/15.6 | 50/10 |
| N₂ Plant Cooling Water Data | | | |
| Supply Temperature (° F.)/(° C.) | 79/26.1 | 61/16.1 | 40/4.4 |
| Return Temperature (° F.)/(° C.) | 94/34.4 | 76/24.4 | 55/12.8 |
| Required Flow of Common Source | | | |
| Cooling Water Supply | 730/2763 | 639/2419 | 525/1987 |
| (gpm)/(L/min) | | | |
| Required Cooling Duty | 5.27/1.54 | 4.63/1.36 | 3.81/1.12 |
| (MMBtu/hr)/(MW) | | | |
| UPW Plant Data | | | |
| Feed Water Stream Flow | 387/1465 | 387/1465 | 387/1465 |
| (gpm)/(L/min) | | | |
| Feed Water Heating Duty | 1.87/ | 3.74/1.10 | 5.61/1.64 |
| (MMBtu/hr)/(MW) | 0.548 | | |
| UPW Recycle Stream Heating Duty | 1.25/ | 1.25/ | 1.25/ |
| (MMBtu/hr)/(MW) | 0.366 | 0.366 | 0.366 |
| Required Heating Duty | 3.12/ | 4.99/1.46 | 6.86/2.01 |
| (MMBtu/hr)/(MW) | 0.914 | | |

On the hottest days, e.g., 1% design day conditions, the nitrogen plant would require 5.27 million Btu/hr (1.54 megawatts (MW)) of cooling duty, while the UPW plant would require 3.12 million Btu/hr (0.914 MW) of heating duty. On the coolest days, e.g., 99% design day conditions, the nitrogen plant would require 3.81 million Btu/hr (1.12 MW) of cooling duty, while the UPW plant would require 6.86 million Btu/hr (2.01 MW) of heating duty. However, if average ambient conditions are examined, the cooling and heating duties are very similar at 4.63 million Btu/hr (1.36 MW) and 4.99 million Btu/hr (1.46 MW) respectively.

### Example

This example describes a computational model describing a integrated nitrogen gas and ultra pure water production plant. The model is based on the embodiment of the present invention shown in the FIGURE. Table 2 shows heating and cooling duties calculated using the integrated nitrogen gas and ultra pure water production plant model.

TABLE 2
Heating and cooling duties of an integrated nitrogen gas and ultra
pure water production plant

| | 1% | | 99% |
|---|---|---|---|
| | Design | | Design |
| Case: | Day | Average | Day |
| Base Data | | | |
| Ambient Temperature (° F.)/(° C.) | 100/37.8 | 70/21.1 | 24/−4.4 |
| Relative Humidity (%) | 37 | 57 | 80 |
| City Water Temperature (° F.)/(° C.) | 70/21.1 | 60/15.6 | 50/10 |
| Cooling Duty | | | |
| Stream 62 Temperature (° F.)/(° C.) | 70/21.1 | 60/15.6 | 50/10 |
| Stream 72 Temperature (° F.)/(° C.) | 80/26.7 | 80/26.7 | 80/26.7 |
| Stream 62 Required Flow | 1078/4081 | 478/1809 | 269/1018 |
| (gpm)/(L/min) | | | |
| Required Cooling Duty | 5.20/1.52 | 4.62/1.35 | 3.90/1.14 |
| (MMBtu/hr)/(MW) | | | |
| Heating Duty | | | |
| Stream 78 Water Flow (gpm)/(L/min) | 387/1465 | 387/1465 | 387/1465 |
| Stream 90 Water Flow (gpm)/(L/min) | — | — | 118/447 |
| Stream 74 Water Flow (gpm)/(L/min) | 691/2616 | 91/344 | — |
| Feed Water (Stream 78) Heating | 0 | 0 | 1.71/ |
| Duty | | | 0.501 |
| (MMBtu/hr)/(MW) | | | |
| Recycle (Stream 124) Heating Duty | 1.25/ | 1.25/ | 1.25/ |
| (MMBtu/hr)/(MW) | 0.366 | 0.366 | 0.366 |
| Total Required Heating Duty | 1.25/ | 1.25/ | 2.96/ |
| (MMBtu/hr)/(MW) | 0.366 | 0.366 | 0.868 |
| UPW Production Energy Savings | | | |
| Heating Duty Savings | 1.87/ | 3.74/1.10 | 3.90/1.14 |
| (MMBtu/hr)/(MW) | 0.548 | | |
| Heating Duty Savings (%) | 60 | 75 | 57 |
| Heating Duty Savings (US$/hr) | 7.5 | 15.0 | 15.6 |

On the hottest days, e.g., 1% design day conditions, the integrated plant requires 5.20 million Btu/hr (1.52 MW) of cooling duty and 1.25 million Btu/hr (0.366 MW) of heating duty. Thus, the integrated plant requires 70,000 Btu/hr (0.0205 MW) less cooling duty than the non-integrated nitrogen gas generation and ultra pure water production plant illustrated in the comparative example. The plant of the comparative example utilizes a cooling tower to provide 79° F. (26.1° C.) cooling water (determined by the wet bulb temperature) while the instant example utilizes municipal water with a temperature of 70° F. (21.1° C.), thus the integrated plant requires less cooling duty. As an additional result of using lower temperature cooling water, the feed air stream of the present example can be cooled to a lower temperature after each compression stage, and thus less compression energy is required and less heat of compression is generated. An excess 691 gpm (2616 L/min) of heated cooling water is generated by the integrated plant. This excess heated water is not required by the UPW plant and is diverted, via stream 74, to other process equipment, for example, to main facility cooling towers as make-up water.

On the coolest days, e.g., 99% design day conditions, the integrated plant requires 3.90 million Btu/hr (1.14 MW) of cooling duty and 2.96 million Btu/hr (0.868 MW) of heating duty. The integrated plant requires 90,000 Btu/hr (0.0264 MW) more cooling duty than the non-integrated nitrogen gas generation and ultra pure water production plant illustrated in the comparative example because the cooling water temperature is 50° F. (10° C.) as determined by the municipal water temperature rather than 40° F. (4.4° C.) determined by the wet bulb temperature. Insufficient heat is available from the nitrogen generation process to provide all of the UPW feed water heating duty. 1.25 million Btu/hr (0.366 MW) is required to reheat the UPW recycle stream and another 1.71 million Btu/hr (0.501 MW) is required to heat additional UPW feed water stream 90.

Under average conditions, the integrated plant requires 4.62 million Btu/hr (1.35 MW) of cooling duty and 1.24 million Btu/hr (0.363 MW) of heating duty. The integrated plant requires approximately the same cooling duty as the non-integrated plant because the municipal water and wet bulb temperature are similar at 60° F. (15.6° C.) and 61° F. (16.1° C.), respectively. While sufficient heat is available to provide all of the UPW feed water heating duty, 1.25 million Btu/hr (0.366 MW) is still required to reheat the UPW recycle stream. An excess of about 90 gpm (341 L/min) of heated cooling water is generated by the integrated plant. This excess heated water is not required by the UPW plant and is diverted, via stream 74, to other process equipment, for example, to main facility cooling towers as make-up water.

Table 2 shows that between about 57% and about 75% UPW feed water heating duty savings can be realized by application of the preferred embodiment of this invention. Assuming a cost of US$4/MMBtu (US$4/0.2931 MW) for boiler fuel, these savings would result in approximately US$15 of savings per hour.

Table 3 contains a numerical example relating to cooling water data of the embodiment of the invention shown in the FIGURE. Again, this data pertains to the same example facility having a capacity of 30,000 eight-inch (20.32 cm) wafers per month. The data given is typical for a modem semiconductor facility of this size.

TABLE 3
Main facility cooling water data

| | 1% | | 99% |
|---|---|---|---|
| | Design | | Design |
| Main Facility Cooling Water Data | Day | Average | Day |
| Cooling Duty (tons refrigeration) | 13,200 | 9,500 | 7,600 |
| Cooling Duty (MMBtu/hr)/(MW) | 158/46.3 | 114/33.4 | 91/26.7 |
| Total Make-up Flow (gpm)/(L/min) | 654/2476 | 471/1783 | 377/1427 |

Table 3 shows that under 1% design day conditions, the main facility cooling towers require 654 gpm (2476 L/min) of make-up water which is a close match with the excess cooling water return volume. Table 3 also shows that, under average conditions, the main facility cooling towers require 471 gpm (1783 L/min) of make-up water.

### EQUIVALENTS

While this invention has been particularly shown and described with references to embodiments thereof, it will be understood by those skilled in the art that various changes in form and details may be made therein without departing from the scope of the invention encompassed by the appended claims.

I claim:

1. A system for producing compressed gas and purified water comprising:
(a) means for compressing a gas, thereby forming a heat source;
(b) means for transferring heat from the heat source to a water stream, thereby forming a heated water stream; and
(c) means for purifying the heated water stream.

2. The system of claim 1 wherein the means for transferring heat from the heat source to the water stream is an indirect heat exchanger.

3. The system of claim 1 wherein the means for purifying the heated water stream is a reverse osmosis water purification device.

4. The system of claim 3 further comprising means for further purifying the heated water stream.

5. The system of claim 4 wherein the means for further purifying the heated water stream comprises one or more devices selected from the group consisting of deionization units, degasification units, ultraviolet sterilization units, and filters.

6. The system of claim 1 wherein the means for purifying the heated water stream is an ultra pure water generation system.

7. The system of claim 1 wherein the means for compressing the gas is a multistage compression apparatus.

8. The system of claim 6 wherein the means for transferring heat from the heat source to a water stream comprises means for providing heat exchange from a compressed gas stream to a water stream at each stage of the multistage compression apparatus.

9. The system of claim 1 further comprising a gas source, the gas source being in fluid communication with the means for compressing the gas.

10. The system of claim 9 wherein the gas source is a nitrogen gas source.

11. The system of claim 1 further comprising means for diverting a portion of the heated water stream from the means for purifying the heated water stream.

12. The system of claim 1 further comprising means for combining the heated water stream with a feed water stream and means for directing the combined streams to the means for purifying the heated water stream.

13. A system for producing compressed gas and purified water comprising:
(a) a gas compressor for producing a compressed gas stream;
(b) at least one heat exchanger having a compressed gas inlet, a compressed gas outlet, a water inlet and a water outlet and wherein heat is transferred from the compressed gas stream to a water stream to produce a heated water stream; and
(c) a water purification apparatus for purifying the heated water stream, the water purification apparatus being in fluid communication with the heat exchanger.

14. The system of claim 13 further comprising means for combining the heated water stream with a feed water stream and means for directing the combined streams to the water purification apparatus for purification of the combined streams.

15. The system of claim 13 wherein the water purification apparatus is a reverse osmosis water purification device.

16. The system of claim 15 further comprising means for further purification of the heated water stream.

17. The system of claim 16 wherein the means for further purification of the heated water stream comprises one or more devices selected from the group consisting of deionization units, degasification units, ultraviolet sterilization units, and filters.

18. The system of claim 13 further comprising a gas source, the gas source being in fluid communication with the gas compressor.

19. The system of claim 18 wherein the gas source is a nitrogen gas source.

20. The system of claim 13 wherein the gas compressor is a multistage gas compressor.

21. A method for producing compressed gas and purified water comprising:
(a) compressing a gas to produce a compressed gas stream;
(b) directing the compressed gas stream through a heat exchanger wherein heat is transferred from the compressed gas to a water stream, thus producing a heated water stream; and
(c) directing the heated water stream to a water purification apparatus wherein the heated water stream is at least partially purified to form a purified water stream.

22. The method of claim 21 wherein the water purification apparatus is a reverse osmosis water purification device.

23. The method of claim 22 further comprising the step of further purifying the purified water stream using one or more devices selected from the group consisting of deionization units, degasification units, ultraviolet sterilization units, and filters.

24. The method of claim 21 wherein the heated water stream is purified to thereby form ultra purified water.

25. The method of claim 21 wherein the heat exchanger is an indirect heat exchanger.

26. The method of claim 21 further comprising the step of employing the compressed gas stream and purified water stream in semiconductor device fabrication.

27. The method of claim 21 further comprising the step of combining the heated water stream with a water feed stream and directing the combined streams into the water purification apparatus.

28. The method of claim 21 further comprising the step of further heating the heated water stream prior to directing the heated water stream to the water purification apparatus.
